(19) United States
(12) Patent Application Publication
(10) Pub. No.: US 2026/0229541 A1
(43) Pub. Date: Aug. 6, 2026

(54) ELECTRODE FOR ALL SOLID STATE BATTERY AND ANODELESS ALL SOLID STATE INCLUDING THE SAME

(71) Applicants: HYUNDAI MOTOR COMPANY, SEOUL (KR); KIA CORPORATION, SEOUL (KR); Research & Business Foundation SUNGKYUNKWAN UNIVERSITY, Suwon-si (KR)

(72) Inventors: Ki Yoon Bae, Hwaseong-si (KR); Ji Young Kim, Hwaseong-si (KR); Jong Chan Song, Hwaseong-si (KR); Sang Heon Lee, Hwaseong-si (KR); Sam Ick Son, Hwaseong-si (KR); Sun Hyeong Kwon, Suwon-si (KR); Byung Gon Song, Suwon-si (KR); Dong Hyoung Kim, Suwon-si (KR); Woo Hyeong Sim, Suwon-si (KR); Hyung Mo Jeong, Suwon-si (KR)

(73) Assignees: HYUNDAI MOTOR COMPANY, SEOUL (KR); KIA CORPORATION, SEOUL (KR); Research & Business Foundation SUNGKYUNKWAN UNIVERSITY, Suwon-si (KR)

(21) Appl. No.: 19/300,232

(22) Filed: Aug. 14, 2025

(30) Foreign Application Priority Data
Feb. 5, 2025 (KR) 10-2025-0014792

(51) Int. Cl. H01M 4/66; C01B 32/194; H01M 4/02; H01M 10/052; H01M 10/0562

(52) U.S. Cl. CPC H01M 4/663; C01B 32/194; H01M 4/667; H01M 10/052; H01M 10/0562; C01B 2204/22; C01P 2002/72; C01P 2004/32; C01P 2004/61; C01P 2004/62; C01P 2006/12; C01P 2006/16; C01P 2006/40; H01M 2004/021; H01M 2300/0068

(57) ABSTRACT

An electrode for an all solid state battery includes at least a current collector, and an intermediate layer including a carbon structure that is disposed on the current collector. The carbon structure includes a spherical carbon material and a layered carbon material in amounts that allow for the formation of a lithium deposition separation space.

### CROSS-REFERENCE TO RELATED APPLICATION

This application claims the benefit of priority to Korean Patent Application No. 10-2025-0014792, filed in the Korean Intellectual Property Office on Feb. 5, 2025, the entire contents of which are incorporated herein by reference.

### TECHNICAL FIELD

The present disclosure relates to an all solid state battery including an intermediate layer to precipitate lithium and an anodeless all solid state battery including the same.

### BACKGROUND

A secondary battery, which is rechargeable, has been used not only in smaller electronic devices, such as cellular phones or laptop computers, but also in larger transportation machinery, such as hybrid or electric vehicles. Given the wide applicability, there remains a need to develop a secondary battery having higher stability and energy density.

For a conventional secondary battery, a cell is mainly formed based on an organic solvent (or an organic liquid electrolyte). Accordingly, a conventional secondary battery has a limitation in improving stability and energy density. Meanwhile, an all solid state battery employing an inorganic solid electrolyte is based on a technology without the need for organic solvent. Recent attention has been given to all solid state battery technology, as it provides a cell that may be manufactured in a more stable and simpler form.

A typical all solid state battery includes a cathode active material layer bonded to a cathode current collector, an anode active material layer bonded to an anode current collector, and a solid electrolyte layer interposed between the anode active material layer and the cathode active material layer. In this arrangement the anode active material layer includes a solid electrolyte for moving lithium ions in addition to the anode active material, such as graphite, and the solid electrolyte has a specific gravity higher than a specific gravity of a liquid electrolyte. Accordingly, the energy density of the all solid state battery is lower than the energy density of a lithium ion battery that includes liquid electrolyte.

Recent research and development on storage type anodeless all solid state batteries has sought to directly precipitate lithium ions on the anode current collector in the form of lithium metal, without the anode active material layer to increase the energy density of the all solid state battery.

A conventional anodeless all solid state battery includes an intermediate layer interposed between the solid electrolyte layer and the anode current collector and including silver (Ag) and a carbon material to uniformly precipitate and deposit lithium. When charging the anodeless all solid state battery, lithium ions (Li+) of the cathode reach the intermediate layer through the solid electrolyte layer. After reacting to form an alloy with silver (Ag), the lithium ions (Lit) are moved and precipitated between the anode current collector and the intermediate layer.

In such an anodeless all solid state battery however, uncontrolled lithium dendrite growth and other side reactions consume active lithium, and cause internal short circuits to shorten the battery lifespan.

### SUMMARY

The present disclosure has been made to solve the above-mentioned problems occurring in the prior art while advantages achieved by the prior art are maintained intact.

An aspect of the present disclosure provides an electrode for an anodeless all solid state battery, which is capable of avoiding, reducing, and/or preventing lithium dendrite growth, and avoids, reduces, and/or prevents lithium from making direct contact with a solid electrolyte.

Another aspect of the present disclosure provides an anodeless all solid state battery which includes an electrode for an all solid state battery that avoids, reduces, and/or prevents lithium dendrite growth and avoids, reduces, and/or prevents lithium from making direct contact with a solid electrolyte, thereby exhibiting an excellent lifespan characteristic and other excellent battery characteristics, relative to the state of the art.

The technical problems to be solved by the present disclosure are not limited to the aforementioned problems, and any other technical problems not mentioned herein but addressed by the aspects and embodiments of the disclosure will be clearly understood from the following description by those skilled in the art to which the present disclosure pertains.
(1) In an aspect according to the present disclosure, an electrode for an all solid state battery includes a current collector, an intermediate layer disposed on the current collector and including a carbon structure. The carbon structure includes a spherical carbon material and layered carbon materials spaced apart from each other around the spherical carbon material to form a lithium deposition separation space.
(2) In an aspect the present disclosure provides an electrode for an all solid state battery, wherein XRD analysis of the carbon structure may exhibit a (002) peak observed in a region having 2θ ranging from 10° to 40°, and a shoulder peak of the (002) peak may be observed in a region having 2θ ranging from 20° to 25°, in (1) above.
(3) In an aspect the present disclosure provides an electrode for an all solid state battery, in which a full width at half maximum (FWHM; 2θ) of a (002) peak ranges 2° to 5° when an X-ray diffraction (XRD) analysis is performed with respect to the carbon structure, in any one of (1) or (2) above.
(4) In an aspect the present disclosure provides an electrode for an all solid state battery, in which a Brunauer-Emmett-Teller (BET) surface area of the carbon structure ranges from 100 m²/g to 160 m²/g, in any one of (1) to (3) above.
(5) In an aspect the present disclosure provides an electrode for an all solid state battery, in which a Barrett-Joyner-Halenda (BJH) average pore diameter of the carbon structure ranges from 3.5 nm to 6.5 nm in any one of (1) to (4) above.
(6) In an aspect the present disclosure provides an electrode for an all solid state battery, in which the layered carbon material includes at least one of graphene platelet, stratified carbon, or a combination of the graphene platelet and the stratified carbon, in any one of (1) to (5) above.
(7) In an aspect the present disclosure provides an electrode for an all solid state battery, in which the layered carbon material (32) has a surface area ranging from 1,000 m²/g to 2,600 m²/g, in any one of (1) to (6) above.
(8) In an aspect the present disclosure provides an electrode for an all solid state battery, in which the spherical carbon material includes at least one of glassy carbon, hard carbon, soft carbon, or a combination of glassy carbon, hard carbon, and soft carbon, in any one of (1) to (7) above.
(9) In an aspect the present disclosure provides an electrode for an all solid state battery, in which the spherical carbon material has an average particle diameter ranging from 0.2 μm to 20 μm, in any one of (1) to (8) above.
(10) According to embodiments of the present disclosure, an anodeless all solid state battery includes an anode current collector, an intermediate layer disposed on the anode current collector and including a carbon structure, a solid electrolyte layer disposed on the intermediate layer, a cathode active material layer disposed on the solid electrolyte layer and including a cathode active material, and a cathode current collector disposed on the cathode active material layer. In embodiments the carbon structure includes a spherical carbon material and a layered carbon material spaced apart from the spherical carbon material, so as to form a lithium deposition separation space.
(11) In an aspect the present disclosure provides an anodeless all solid state battery in which a lithium ion is deposited in the lithium deposition separation space of the intermediate layer when the anodeless all solid state battery is charged, in (10) above.
(12) In an aspect the present disclosure provides an anodeless all solid state battery in which the lithium ion is deposited in the lithium deposition separation space of the intermediate layer through a Coble creep mechanism, in (11) above.
(13) In an aspect the present disclosure provides an anodeless all solid state battery in which a lithium deposit is interposed in a separation space of the intermediate layer, and a lithium deposition layer is additionally included between the intermediate layer and the anode current collector when the anodeless all solid state battery is fully charged, in any one of (10) to (12) above.
(14) In an aspect the present disclosure provides an anodeless all solid state battery in which the solid electrolyte layer includes a sulfide-based solid electrolyte, in any one of (10) to (13) above.

### BRIEF DESCRIPTION OF THE DRAWINGS

The above and other objects, features and advantages of the present disclosure will be more apparent from the following detailed description taken in conjunction with the accompanying drawings:

FIG. 1 schematically illustrates a structure of an anodeless all solid state battery, depending on driving states, according to an embodiment of the present disclosure;

FIGS. 2, 3, and 4 illustrate SEM images obtained by capturing a procedure for preparing a carbon structure according to an embodiment of the present disclosure;

FIG. 5 is an SEM image obtained by capturing a carbon structure according to Embodiment 1 of the present disclosure;

FIG. 6 is an SEM image obtained by capturing a carbon structure to determine the structure change of the carbon structure after applying pressure to an electrode including a carbon structure according to Embodiment 1 of the present disclosure;

FIG. 7 illustrates an XRD spectrum for each of carbon structures according to Embodiment 1 and Comparative example 1 of the present disclosure;

FIG. 8 illustrates a Barrett-Joyner-Halenda (BJH) Plot for each of carbon structures according to Embodiment 1 and Comparative example 1 of the present disclosure;

FIG. 9 illustrates Micropore distribution for each of carbon structures according to Embodiment 1 and Comparative example 1 of the present disclosure;

FIG. 10 illustrates an SEM image obtained by capturing a cross-section for each of electrodes including carbon structures according to Embodiment 1 of the present disclosure and Comparative example 1;

FIG. 11 illustrates an SEM image obtained by capturing a cross-section for each of electrodes including carbon structures according to Embodiment 1 of the present disclosure and Comparative example 1, after lithium is deposited on the electrodes;

FIG. 12 is a graph illustrating a capacity retention and Coulombic efficiency measured per cycle of a half-cell including the carbon structure of Comparative Example 1 of the present disclosure;

FIG. 13 is a graph illustrating a capacity retention and Coulombic efficiency measured per cycle of a half-cell including the carbon structure of Embodiment 1 of the present disclosure; and

FIG. 14 is a graph illustrating an initial driving characteristic of each half-cell including each of the carbon structures according to Embodiment 1 and Comparative Example 2 of the present disclosure.

### DETAILED DESCRIPTION

Hereinafter, the present disclosure will be described in more detail for the understanding of the present disclosure.

Unless defined otherwise by the disclosure, all technical and scientific terms used herein should be given their ordinary and customary meaning as commonly understood by one of ordinary skill in the art to which the disclosure belongs. A number of terms and abbreviations appear throughout the disclosure and, unless otherwise defined or indicated, should be understood to have their reasonably broad commonly understood and plain meanings that are consistent with the context in which the terms are used.

As used herein, referent terms such as “first,” “second,” “initial,” “subsequent,” and the like, may be used for describing various components, but the components are not limited by the terms. These terms are only used to distinguish one component from another component. For example, without departing from the scope of the present disclosure, a first component may be named as a second component, and similarly, a second component may be named as a first component.

The terms used herein are used for describing particular embodiments only and are not intended to limit the present disclosure. A singular expression includes a plural expression unless otherwise defined differently in a context. In the present disclosure, it should be understood that term “comprising” or “having” or “including” (or comprises, has, or includes) indicates that a feature, a number, a step, an operation, a component, a part or a combination thereof described in the specification is present, but does not exclude a possibility of the presence or addition of one or more other features, numbers, steps, operations, components, parts or combinations thereof, in advance. It will be appreciated that those terms are also inclusive of the term “consisting of” or “consisting essentially of” which, when used throughout the disclosure or claims, generally indicate that a feature, a number, a step, an operation, a component, a part or a combination thereof described in the specification is present, and does not include any additional feature(s).

### <Anodeless all Solid State Battery>

In an aspect, the present disclosure provides an anodeless all solid state battery including an electrode for an all solid state battery.

According to an embodiment of the present disclosure, the anodeless all solid state battery comprises an anode current collector, an intermediate layer disposed on the anode current collector and including a carbon structure, a solid electrolyte layer disposed on the intermediate layer, a cathode active material layer disposed on the solid electrolyte layer and including a cathode active material, and a cathode current collector disposed on the cathode active material layer. In embodiments, the carbon structure includes amounts of a spherical carbon material and a layered carbon material spaced apart from the spherical carbon material in a configuration that can form a separation space with the spherical carbon material.

In a general sense, aspects of an all solid state battery in accordance with the disclosure include a cathode active material layer bonded to a cathode current collector, an anode active material layer bonded to an anode current collector, and a solid electrolyte layer interposed between the anode active material layer and the cathode active material layer. In embodiments, the anode active material layer includes a solid electrolyte capable of moving lithium ions in addition to the anode active material, such as graphite, and the solid electrolyte has a specific gravity higher than a specific gravity of a liquid electrolyte. Accordingly, an energy density of the all solid state battery is lower than an energy density of a lithium ion battery using liquid electrolyte.

As noted herein, pursuit of an anodeless all solid state battery in a storage type to directly precipitate lithium ions on the anode current collector in the form of lithium metal, without the anode active material layer, to increase energy density.

A conventional anodeless all solid state battery includes an intermediate layer disposed interposed between the solid electrolyte layer and the anode current collector and including a carbon material, to uniformly precipitate and deposit lithium. When charging these conventional anodeless all solid state battery, lithium ions (Li+) of the cathode reach the intermediate layer through the solid electrolyte layer. After making reaction with the carbon material and moving, the lithium ions (Lit) are precipitated between the anode current collector and the intermediate layer. However, when typical graphite, as carbon material, is included in the intermediate layer of the anodeless all solid state battery, active lithium is consumed due to uncontrolled lithium dendrite growth and one or more side reactions, and lithium ions are precipitated between the solid electrolyte layer and the intermediate layer due to the crystallinity of graphite, thereby causing an internal short circuit. Accordingly, the lifespan of conventional anodeless all solid state battery may be shortened.

According to an embodiment of the present disclosure, the anodeless all solid state battery may include a carbon structure including a spherical carbon material and a layered carbon material. When the anodeless all solid state battery is charged and when the lithium ion is deposited, the lithium ion may be prevented from being deposited in the form of an additional layer, and charging and discharging efficiency may be improved at an initial stage. Accordingly, such a structure can prevent any internal short circuit, which is typically caused as a lithium deposition layer is separately formed between the solid electrolyte layer and the intermediate layer, and thereby improve battery lifespan.

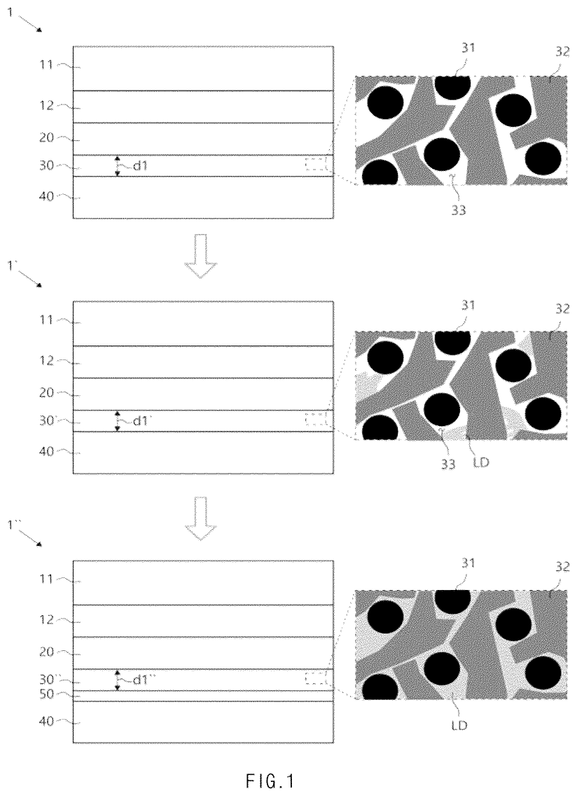

Hereinafter, each component constituting anodeless all solid state battery according to an embodiment of the present disclosure will be described in detail with reference to the illustrative embodiment depicted in FIG. 1. The figure schematically illustrates a structure of the anodeless all solid state battery, depending on driving states, according to an embodiment of the present disclosure. For example, FIG. 1 illustrates an anodeless all solid state battery 1 in an initial state (i.e., a fully discharged state before initial charging, top panels), an anodeless all solid state battery 1′ during charging (middle panels), and an anodeless all solid state battery 1″ in a fully charged state (bottom panels). Hereinafter, each component of the anodeless all solid state battery according to an embodiment of the present disclosure will be described with reference to the anodeless all solid state battery 1 in an initial state unless defined otherwise.

### 1. Electrode for all Solid State Battery

The anodeless all solid state battery according to an embodiment of the present disclosure may include an electrode for the all solid state battery. The electrode for the all solid state battery at least includes a current collector, and an intermediate layer disposed on the current collector and including a carbon structure as described herein. In embodiments, the carbon structure includes a spherical carbon material 31 and a layered carbon material 32 spaced apart from the spherical carbon material, in the vicinity of the spherical carbon material to form a lithium deposition separation space 33.

According to an embodiment of the present disclosure, the electrode for the all solid state battery may be an anode which is formed upon direct precipitation of lithium ions, in the form of lithium metal, on a current collector without an anode active material layer. Accordingly, the current collector included in the electrode for the anodeless all solid state battery is referred to in some embodiments as an anode current collector 40.

### Anode Current Collector

According to an embodiment of the present disclosure, the anode current collector 40, which serves as a plate-shaped base having electrical conductivity, may include a material which does not react, or does not substantially react, with lithium.

Specifically, the anode current collector 40 can include various materials without being particularly limited, as long as the materials have conductivity without inducing a chemical change in the battery (i.e., the anodeless all solid state battery according to the present disclosure). As non-limiting examples, the anode current collector 40 may be at least one of aluminum (Al), nickel (Ni), titanium (Ti), tungsten (W), iron (Fe), chromium (Cr), and stainless steel, or an alloy thereof. In some embodiments, the anode current collector 40 may be at least one selected from the group consisting of aluminum (Al), nickel (Ni), titanium (Ti), tungsten (W), iron (Fe), chromium (Cr), and stainless steel, and an alloy thereof.

### Intermediate Layer

According to an embodiment of the present disclosure, the intermediate layer 30, directly disposed on the anode current collector 40, may induce depositing of lithium metal in a horizontal direction along the surface of the anode current collector 40, when lithium ions are precipitated in the form of lithium metal on the anode current collector 40.

According to an embodiment of the present disclosure, the intermediate layer 30 may include a carbon structure including a spherical carbon material 31 and a layered carbon material 32 spaced apart from the spherical carbon material 31, and arranged to form a lithium deposition separation space 33.

According to an embodiment of the present disclosure, the spherical carbon material 31 may have an average particle diameter ranging from 0.2 μm to 20 μm. According to the present disclosure, the term “spherical” should be understood as inclusive of shapes similar to a sphere, such as, for example, ovate, oblong, or elongated ellipsoid shapes, as well as a sphere having a sphericity of about 1. According to the present disclosure, the average particle diameter of the spherical carbon material 31 may be measured using a dynamic light scattering method. In some embodiments, the average particle diameter refers to an arithmetic average particle diameter, that is, an average particle diameter of scattering intensity in a particle size distribution measured by the dynamic light scattering manner (e.g., D₅₀, D₉₀, etc.).

According to an embodiment of the present disclosure, the spherical carbon material 31 may comprise an average particle diameter of at least 0.4 μm, at least 0.6 μm, at least 0.8 μm, at least 1.0 μm, at least 2.0 μm, or at least 4.0 μm and, in some embodiments, may comprise an average particle diameter of at most 18 μm, at most 16 μm, at most 14 μm, at most 12 μm, or at most 10 μm.

According to an embodiment of the present disclosure, the spherical carbon material 31 may include at least one of glassy carbon, hard carbon, soft carbon, or a combination thereof. In embodiments, the spherical carbon material 31 may include at least one selected from the group consisting of glassy carbon, hard carbon, soft carbon, and combinations thereof.

According to an embodiment of the present disclosure, the layered carbon material 32 may comprise a particle having a plate shape. According to the present disclosure, the term “plate” should be understood as including a flat, generally planar shape, which has a generally uniform thickness profile, and a curved shape (i.e., with one or more of convex or concave regions).

According to an embodiment of the present disclosure, the layered carbon material 32 may be plate shape materials having a thickness ranging from 10 nm to 100 nm. In some embodiments, the layered carbon material 32 may have a thickness of at least 12 nm, at least 14 nm, at least 16 nm, at least 18 nm, at least 20 nm, or at least 30 nm, and, in some other embodiments, may have a thickness of at most 95 nm, at most 90 nm, at most 85 nm, at most 80 nm, at most 75 nm, at most 70 nm, or at most 60 nm.

According to an embodiment of the present disclosure, a diameter D₅₀ corresponding to 50% of the cumulative volume in a cumulative volume distribution of the layered carbon material 32 measured through a Laser Diffraction Grain Size Analyzer may range from 5 μm to 12 μm. In some embodiments, the diameter (D₅₀) may be at least 5.5 μm, at least 6 μm, at least 6.5 μm, at least 7 μm, at least 7.5 μm, or at least 8 μm, and, in some other embodiments, may be at most 11.5 μm, at most 11 μm, at most 10.5 μm, at most 10 μm, at most 9.5 μm, or at most 9 μm. In embodiments wherein the diameter (D₅₀) satisfies the above range, the lithium deposition mechanism may be easily performed and achieved, such that lithium may be smoothly deposited inside the carbon structure.

According to an embodiment of the present disclosure, a diameter D₁₀ corresponding to 10% of the cumulative volume in a cumulative volume distribution of the layered carbon material 32 measured through a Laser Diffraction Grain Size Analyzer may range from 1.5 μm to 4.5 μm. In some embodiments, the diameter (D₁₀) may be at least 1.6 μm, at least 1.7 μm, at least 1.8 μm, at least 1.9 μm, or at least 2 μm, and, in some other embodiments, at most 4.4 μm, at most 4.3 μm, at most 4.2 μm, at most 4.1 μm or at most 4 μm. In embodiments wherein the diameter D₁₀ satisfies the above range, the lithium deposition mechanism (as described below) may be readily performed and achieved.

According to an embodiment of the present disclosure, a diameter D₉₀ corresponding to 90% of the cumulative volume in a cumulative volume distribution of the layered carbon material 32 measured through a Laser Diffraction Grain Size Analyzer may range from 13 μm to 25 μm. In some embodiments, the diameter (D₉₀) may be at least 13.5 μm, at least 14 μm, at least 14.5 μm, at least 15 μm, at least 15.5 μm, or at least 16 μm, and, in some other embodiments, at most 24.5 μm, at most 24 μm, at most 23.5 μm, at most 23 μm, at most 22.5 μm, or at most 22 μm. In embodiments wherein the diameter Doo satisfies the above range, the lithium deposition mechanism, e.g., as described herein below, may be more readily performed and achieved.

According to an embodiment of the present disclosure, the layered carbon material 32 may have a SPAN value of at most 1.9 based on following Equation 1:

$$\overline{SPAN = \frac{{D}_{90} - {D}_{10}}{{D}_{50}}} , \qquad [ Equation 1 ]$$

### In Equation 1,

D₁₀ is a diameter (D₁₀) corresponding to 10% of the cumulative volume, based on the cumulative volume distribution of the layered carbon material,
D₅₀ is a diameter (D₅₀) corresponding to 50% of the cumulative volume, based on the cumulative volume distribution of the layered carbon material, and
D₉₀ is a diameter (D₉₀) corresponding to 90% of the cumulative volume, based on the cumulative volume distribution of the layered carbon material.

According to the present disclosure, the SPAN value expressed based on Equation 1 may be, in some specific embodiments, at least 0.5, at least 0.6, at least 0.8, at least 1, at least 1.2 or at least 1.4, and in some other specific embodiments at most 1.85, at most 1.8, at most 1.75, at most 1.7, or at most 1.65. In embodiments wherein the SPAN value satisfies the above range, the lithium deposition mechanism described herein below may be more readily performed.

According to an embodiment of the present disclosure, the layered carbon material 32 may be a graphene platelet material in which graphene can be disorderly stacked or stratified carbon, and in which graphene is combined.

According to an embodiment of the present disclosure, layered carbon materials 32 may surround the spherical carbon material 31. The structure comprising the distributed layered (32) and spherical (31) carbon materials (e.g., over the entire portion or a partial portion of the carbon structure layer) allows for the formation of the lithium deposition separation space 33. The lithium deposition separation space 33 may be a space in which lithium is precipitated, for example, when the anodeless all solid state battery is charged.

According to an embodiment of the present disclosure, when the anodeless all solid state battery is charged, lithium ions may be deposited in the lithium deposition separation space 33 through a Coble creep mechanism. In further embodiments, the Coble creep mechanism may be induced by the layered carbon material 32 and the spherical carbon material 31 included in the carbon structure.

For example, referring to FIG. 1, middle panels, for the anodeless all solid state battery 1′ during charging, a lithium deposition body (LD) may be formed in a portion of the lithium deposition separation space 33. In such embodiments, the lithium deposition separation space 33 comprise volume and space to grow additional lithium deposition body LD. Accordingly, a thickness d1′ of the intermediate layer 30 during charging may be substantially equal to the thickness d1 of the intermediate layer 30 in the initial state.

Referring to FIG. 1, bottom panels, for the anodeless all solid state battery 1″ in the fully charged state, the lithium deposition body LD may be filled in the entire portion of the lithium deposition separation space 33, and a lithium deposition layer 50 may be formed between the intermediate layer 30″ and the anode current collector 40. In specific embodiments relating to the anodeless all solid state battery 1″ in the fully charged state, when the lithium deposition body may be formed in excess of the lithium deposition separation space the layered carbon material 32 can fail to receive the lithium deposition body, forming a separate lithium deposition layer 50 between the intermediate layer 30″ and the anode current collector 40. Accordingly, the thickness d1 of the intermediate layer 30 in the initial state may be substantially equal to the thickness d1″ of the intermediate layer 30″ in the fully charged state.

According to an embodiment of the present disclosure, the layered carbon material 32 may have the surface area ranging from 1,000 m²/g to 2,600 m²/g. In some embodiments, the layered carbon material 32 may have a surface area of at least 1,100 m²/g, at least 1,200 m²/g, at least 1,300 m²/g, at least 1,400 m²/g, or at least 1,500 m²/g, and, in some other embodiments, may have a surface area of at most 2,400 m²/g, at most 2,200 m²/g, at most 2,000 m²/g, at most 1,800 m²/g, or at most 1,600 m²/g. In embodiments wherein the surface area satisfies the above range, the Coble creep mechanism may be induced such that lithium metal is effectively deposited in the lithium deposition separation space 33.

As described above, for the carbon structure according to an embodiment of the present disclosure, the layered carbon material 32 and the spherical carbon material 31 are combined together, thereby inducing the Coble creep mechanism that allows for effective deposition of the lithium ions in the lithium deposition separation space 33 (i.e., a separation space between the layered carbon material 32 and the spherical carbon material 31). When a carbon material other than a layered carbon material (for example, a linear carbon material, such as CNT) that has a form different from the layered carbon material 32 is included with the spherical carbon material 31 to form the lithium deposition separation space, the resulting surface area for the lithium metal may be reduced (relative to the layered carbon material). According to such embodiments, the deposition of the lithium metal may not be easily or readily performed.

According to an embodiment of the present disclosure, the carbon structure may include the spherical carbon material 31 and the layered carbon material 32 in a weight ratio (of the spherical carbon material: the layered carbon material) ranging from 1:1 to 1:19. In some embodiments, the weight ratio (of the spherical carbon material: the layered carbon material) may include at least 1:2, at least 1:3, at least 1:4, at least 1:5, at least 1:6, or at least 1:7, and, in other embodiments, at most 1:18, at most 1:17, at most 1:16, at most 1:15, at most 1:14, or at most 1:13. In embodiments wherein the above range is satisfied, the lithium ion may be more effectively deposited in the lithium deposition separation space 32 in the carbon structure.

Using XRD analysis to characterize the carbon structure according to an embodiment of the present disclosure, a (002) peak may be observed in a region having 2θ ranging from 10° to 40°, and a shoulder peak of the (002) peak may be observed in a region having ranging from 20° to 25°. The carbon structure according to an embodiment of the present disclosure includes an amorphous spherical carbon material as well as a crystalline layered carbon material, which typically results in an observed amorphous peak.

According to the present disclosure, the shoulder peak, which typically appears as an asymmetric extension region around a main peak (as two peaks having mutually different intensities are superimposed with each other) may not be determined as an independent peak. In some embodiments, the shoulder peak appears as a portion of the main peak. In embodiments, the shoulder peak may be determined as being present when the shape of peaks corresponding to opposite side portions of the maximum intensity Bragg angle, which indicates the maximum intensity of the main peak, appear asymmetrical. In some embodiments, the shoulder peak may indicate a portion having a stronger intensity, when profiles of the peaks corresponding to the opposite side portions of the maximum intensity Bragg angle are compared to each other.

According to an embodiment of the present disclosure, when XRD analysis is performed with respect to the carbon structure, a full width half maximum (FWHM; 2θ) of a (002) peak may range 2° to 5°. In embodiments wherein the above range is satisfied, the lithium ion may be more effectively deposited in the lithium deposition separation space 32 in the carbon structure.

According to an embodiment of the present disclosure, in the carbon structure, a BET specific surface area measured through a nitrogen gas adsorption method may range from 100 m²/g to 160 m²/g. In embodiments wherein the above range is satisfied, the lithium ion may be more effectively deposited in the lithium deposition separation space 32 in the carbon structure.

According to an embodiment of the present disclosure, in the carbon structure, an average pore diameter determined through a Barrett-Joyner-Halenda (BJH) method may range from 3.5 nm to 6.5 nm. In embodiments wherein the above range is satisfied, the lithium ion may be more effectively deposited in the lithium deposition separation space 32 in the carbon structure.

According to an embodiment of the present disclosure, the carbon structure may be prepared by mixing a layered carbon material precursor and a spherical carbon material precursor at a weight ratio (of the spherical carbon material: the layered carbon material) ranging from 1:1 to 1:19. In some embodiments, the carbon structure may be prepared by mixing a weight ratio of the layered carbon material precursor to the spherical carbon material precursor of at least 1:2, at least 1:3, at least 1:4, at least 1:5, at least 1:6, or at least 1:7, and, in some embodiments, at most 1:18, at most 1:17, at most 1:16, at most 1:15, at most 1:14, or at most 1:13.

According to an embodiment of the present disclosure, a layered carbon material precursor may comprise plate shape particles having a width ranging from 10 μm to 20 μm, when viewed in a plan view. In additional embodiments, the layered carbon material precursor may be graphene.

According to an embodiment of the present disclosure, the spherical carbon material may comprise spherical particles having an average diameter D₅₀ ranging from 1 μm to 4 μm. In embodiments, the spherical carbon material precursor may include at least one of carbon black, graphite, or combinations thereof. The carbon black may for example include acetylene black, ketjen black, channel black, furnace black, thermal black, Super C, and/or Super P.

According to an embodiment of the present disclosure, the carbon structure may be prepared by mixing the layered carbon material precursor and the spherical carbon material precursor at a ratio described above, and heat treating the resulting mixture. The layered carbon material precursor and the spherical carbon material precursor may be changed to the layered carbon material and the spherical carbon material, respectively, as a result of the heat treatment. The layered carbon material and the spherical carbon material in accordance with the aspects and embodiments described above can be used in accordance with the following description of the method.

According to an embodiment of the present disclosure, the carbon structure may be prepared by mixing the layered carbon material precursor and the spherical carbon material precursor, performing heat treatment on the resulting mixture, and compositing the heat treated mixture through mechanical milling through known techniques such as, for example, ball milling.

According to an embodiment of the present disclosure, the intermediate layer 30 may further include one or more of a conductive material, a solid electrolyte, and/or a binder.

According to an embodiment of the present disclosure, the conductive material may further improve the conductivity of the intermediate layer 30. The conductive material may include various materials without particular limitation, as long as the materials have conductivity without inducing a chemical change in the battery (e.g., the anodeless all solid stage battery according to the present disclosure). For example, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as a carbon fluoride, aluminum powders, or nickel powders; a conductive whisker such as zinc oxide or potassium titanate; a conductive metal oxide such as a titanium oxide; and/or a conductive material, such as a material comprising a polyphenylene derivative.

According to an embodiment of the present disclosure, the binder may facilitate the binding between the conductive material and the carbon structure. In some non-limiting embodiments, the binder may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nitrile-butadiene rubber, fluorine rubber, and various copolymers thereof.

The intermediate layer 30 according to an embodiment of the present disclosure may include the carbon structure in an amount ranging from 85 wt. % to 99 wt. %, and in some specific embodiments, may include the carbon structure in a content at least 86 wt. %, at least 87 wt. %, at least 88 wt. %, at least 89 wt. %, or at least 90 wt. %, and, in some other specific embodiments, at most 98 wt. %, at most 97 wt. %, at most 96 wt. %, at most 95 wt. %, at most 94 wt. %, or at most 93 wt. %. In embodiments wherein the above range is satisfied, the lithium ion may be more effectively deposited in the lithium deposition separation space 32 in the carbon structure.

The intermediate layer 30 according to an embodiment of the present disclosure may include the carbon structure at a density ranging from 0.8 g/cm³ to 2.0 g/cm³. In some embodiments, the carbon structure may be included at the density of at least 0.9 g/cm³, at least 1.0 g/cm³, at least 1.1 g/cm³, at least 1.2 g/cm³, at least 1.3 g/cm³, or 1.4 g/cm³, and, in some other embodiments, may be included at the density of at most 1.9 g/cm³, at most 1.8 g/cm³, at most 1.7 g/cm³, at most 1.6 g/cm³, or at most 1.5 g/cm³. In embodiments wherein the above range is satisfied, the lithium ion may be more effectively deposited in the lithium deposition separation space 32 in the carbon structure.

According to an embodiment of the present disclosure, the intermediate layer 30 may have a thickness (d1) ranging from 5 μm to 20 μm. In some embodiments, the thickness (d1) may be at least 5.5 μm, at least 6 μm, at least 6.5 μm, at least 7 μm, at least 7.5 μm, or at least 8 μm, or, in some other embodiments, may be at most 19 μm, at most 18 μm, at most 17 μm, at most 16 μm, or at most 15 μm. In embodiments wherein the above range is satisfied, the lithium ion may be more effectively deposited in the lithium deposition separation space 32 in the carbon structure.

### 2. Solid Electrolyte Layer

According to an embodiment of the present disclosure, the all solid state battery may include the solid electrolyte layer 20. The solid electrolyte layer 20 may be interposed between the cathode active material layer 12 and the intermediate layer 30 and can transfer lithium ions between the cathode active material layer 12 and the anode current collector 40.

According to an embodiment of the present disclosure, the solid electrolyte layer 20 may be disposed on the intermediate layer 30 and may include a solid electrolyte having lithium ion conductivity. In embodiments, the solid electrolyte include at least one of an oxide-based solid electrolyte, a sulfide-based solid electrolyte, a polymer electrolyte, or a combination thereof. In some preferred embodiments the solid electrolyte may include a sulfide-based solid electrolyte. In some embodiments, the solid electrolyte is selected from the group consisting of an oxide-based solid electrolyte, a sulfide-based solid electrolyte, a polymer electrolyte, and a combination thereof.

According to further embodiments of the present disclosure, the sulfide-based solid electrolyte may include at least one of Li₆PS₅X (X=at least one selected from the group consisting of Cl, Br and I), Li₁₀GeP₂S₁₂, Li₃PS₄, Li₇P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—PzS₅—ZmSn (in which ‘m’ and ‘n’ is positive numbers; Z is one of Ge, Zn, and Ga), Li₂S—GeS₂, Li₂S—SiS₂—Li₃PO₄, Li₂S—SiS₂-LiₓMO_{y} (in which ‘x’ and ‘y’ are positive numbers; M is one among P, Si, Ge, B, Al, Ga, and In), or a combination thereof. In some embodiments the sulfide-based solid electrolyte is selected from the group consisting of Li₆PS₅X (X=at least one selected from the group consisting of Cl, Br and I), Li₁₀GeP₂S₁₂, Li₃PS₄, Li₇P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (in which ‘m’ and ‘n’ is positive numbers; Z is one of Ge, Zn, and Ga), Li₂S—GeS₂, Li₂S—SiS₂—Li₃PO₄, Li₂S—SiS₂—LiₓMO_{y} (in which ‘x’ and ‘y’ are positive numbers; M is one among P, Si, Ge, B, Al, Ga, and In), and a combination thereof.

### 3. Cathode

In an embodiment of the present disclosure, the cathode may include the cathode active material layer 12 and the cathode current collector 11.

### Cathode Active Material Layer

According to an embodiment of the present disclosure, the cathode active material layer 12 may include a cathode active material, a conductive material, and a binder.

According to an embodiment of the present disclosure, the cathode active material, which allows lithium ions (Lit) to be reversibly deposited or released, may include a composite oxide (or a lithium composite metal oxide) of lithium and a metal. In some non-limiting embodiments, the lithium composite metal oxide may be a lithium-manganese-based oxide (e.g., LiMnO₂ or LiMn₂O₄), a lithium-cobalt-based oxide (e.g., LiCoO₂), a lithium-nickel-based oxide (e.g., LiNiO₂), a lithium-nickel-manganese-based oxide (e.g., LiNi_{1-Y}Mn_{Y}O₂ (0<Y<1), or LiMn_{2-z}Ni_{z}O₄ (0<Z<2)), a lithium-nickel-cobalt-based oxide (e.g., LiNi_{1-Y1}CO_{Y1}O₂ (0<Y1<1)), a lithium-manganese-cobalt-based oxide (e.g., LiCO_{1-Y2}Mn_{Y2}O₂ (0<Y2<1), or LiMn_{2-z1}Co_{z1}O₄ (0<Z1<2)), a lithium-nickel-manganese-cobalt-based oxide (e.g., Li(NiₚCo_{q}Mnᵣ₁)O₂ (0<p<1, 0<q<1, 0<r1<1, and p+q+r1=1) or Li(Niₚ₁Co_{q1}Mnᵣ₂)O₄ (0<p1<2, 0<q1<2, 0<r2<2, and p1+q1+r2=2)), or a lithium-nickel-cobalt-transition metal (M) oxide (e.g., Li(Niₚ₂Co_{q2}Mnᵣ₃M_{S2})O₂ (‘M’ is selected from the group consisting of Al, Fe, V, Cr, Ti, Ta, Mg, and Mo; p2, q2, r3 and s2 represent atomic fractions of independent elements; 0<p><1, 0<q2<1, 0<3<1, 0<s2<1, p2+q2++3+s2=1)), or may include any one of the above materials or a compound including at least two of the above materials.

In some further embodiments, the lithium composite metal oxide may be LiCoO₂, LiMnO₂, LiNiO₂, a lithium nickel manganese cobalt oxide (e.g., Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂ and Li(Ni_{0.8}Mn_{0.1}Co_{0.1})O₂), or a lithium nickel cobalt aluminum oxide (e.g., Li(Ni_{0.8}Co_{0.15}Al_{0.05})O₂), any of which can enhance a capacity characteristic and stability of a battery in accordance with the disclosure. In some preferred embodiments controlling the type and content ratio of components forming the lithium composite metal oxide can markedly improve one or more characteristics. In accordance with some embodiments, the of lithium composite metal oxide comprise any or all Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, or Li(Ni_{0.8}Mn_{0.1}Co_{0.1})O₂, inclusive of any mixtures of at least two of the above materials.

According to an embodiment of the present disclosure, the cathode active material may include boron (B) or LiNbO, and may further include a coating layer surrounding the lithium composite metal oxide. Embodiments that comprise the coating layer, may exhibit improved structural stability of the cathode active material.

In additional embodiments of the present disclosure, the cathode active material layer 12 may further include a solid electrolyte. In embodiments, the solid electrolyte may coat the cathode active material. Accordingly, embodiments comprising a solid electrolyte can improve the interfacial compatibility between the cathode active material layer 12 and the solid electrolyte layer 20. The solid electrolyte as detailed above can be used in accordance with these embodiments.

According to an embodiment of the present disclosure, the conductive material may further improve the conductivity of the cathode active material. The conductive material may include various materials, without being particularly limited, as long as the materials have conductivity without inducing a chemical change in the battery. In some non-limiting embodiments, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as carbon fluoride, aluminum powders, or nickel powders; a conductive whisker such as a zinc oxide or a potassium titanate; a conductive metal oxide such as a titanium oxide; and a conductive material, such as a polyphenylene derivative.

According to an embodiment of the present disclosure, the binder may facilitate bonding between the conductive material, the cathode active material, and the cathode current collector. In embodiments, the binder may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nitrile-butadiene rubber, fluorine rubber, or various copolymers thereof.

### Cathode Current Collector

According to an embodiment of the present disclosure, the cathode current collector 11 is not particularly limited as long as it has conductivity without causing a chemical change in the battery. In embodiments, the cathode current collector may be at least one of aluminum (Al), nickel (Ni), titanium (Ti), tungsten (W), iron (Fe), chromium (Cr), and stainless steel, or an alloy thereof. In some embodiments, the cathode current collector is selected from the group consisting of aluminum (Al), nickel (Ni), titanium (Ti), tungsten (W), iron (Fe), chromium (Cr), and stainless steel, and an alloy thereof.

Hereinafter, embodiments in accordance with the disclosure will be described in detail such that those skilled in the art may easily reproduce embodiments within the scope of the present disclosure. However, it will be appreciated that the present disclosure may be implemented in various forms, and is not limited to the illustrative example embodiments that follow.

### Embodiment 1

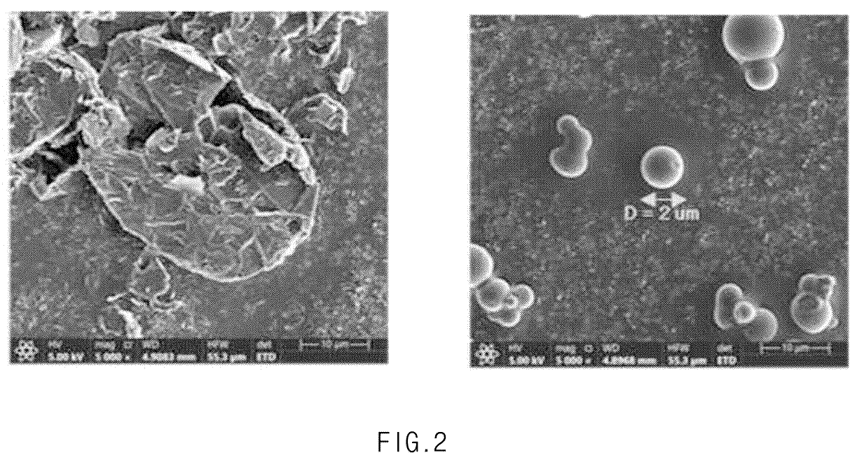

1 g of a mixture containing a layered carbon material precursor (Graphene supermarket; product name: nanopowder 12 nm flakes AO-3) having the width ranging from 10 μm to 20 μm (when viewed in a plan view), and a spherical carbon material precursor (Sigma-Aldrich; product name: Carbon (glassy, spherical powder, 2-12 μm)) having an average particle size of 2 μm, were combined in a weight ratio of 95:5, respectively. The mixture was introduced into a reactor containing 100 ml of acetone, and stirred. FIG. 2 illustrates an SEM image of each precursor (i.e., graphene precursor and spherical carbon). The SEM image was captured through a scanning electron microscope (Thermofisher; Apreo 2S).

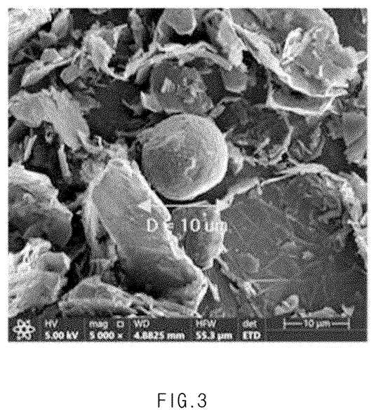

Cyanoacrylate adhesive (100 g Loctite; product name: Loctite401) was introduced into the reactor to initiate a reaction. After the reaction was finished, the reaction product was dried in a vacuum oven at 80° C. for 3 hours and then pulverized. 2 g of the pulverized material was left at 120° C. for 10 minutes in an N₂ and H₂ atmosphere. Heat treatment (at 400° C. for 1 hour) was performed with respect to the material through CVD. The SEM image of the heat-treated result is illustrated in FIG. 3. The SEM image was captured through a scanning electron microscope (Thermofisher; Apreo 2S).

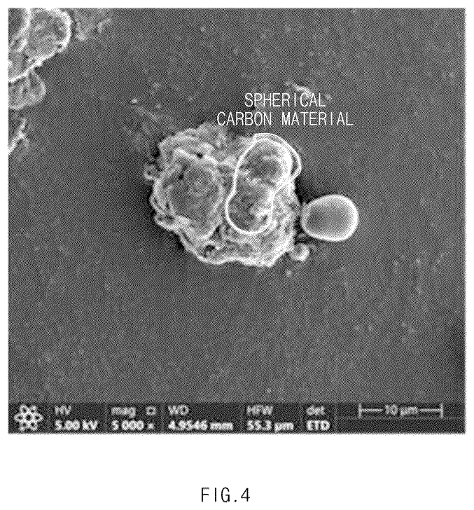

The heat-treated result was collected and a ball mill process was performed with respect to the heat-treated result using a SUS container and a ball, to obtain carbon structure powders including the spherical carbon material and the layered carbon material. The SEM image of the obtained carbon structure powders is illustrated in FIG. 4. The SEM image was captured through a scanning electron microscope (Thermofisher; Apreo 2S).

### Comparative Example 1

1 g of a layered carbon material precursor (Graphene supermarket; product name: nanopowder 12 nm flakes AO-3) having a width ranging from 10 μm to 20 μm when viewed in a plan view was introduced into a reactor containing 100 mL of acetone and stirred. Thereafter, 100 g of cyanoacrylate adhesive (Loctite; product name: Loctite401) was introduced into the reactor to initiate a reaction. After the reaction was finished, the reaction product was dried in a vacuum oven at 80° C. for 3 hours and then pulverized. 2 g of the pulverized material was left at 120° C. for 10 minutes in an N₂ and H₂ atmosphere, and left at 400° C. for 1 hour, and heat treatment was performed with respect to the result through CVD. The heat-treated result was collected and a ball mill process was performed with respect to the heat-treated result using a SUS container and a ball, thereby obtaining carbon structure powders including a layered carbon material.

### Comparative Example 2

1 g of a mixture containing a carbon nano-tube (manufactured by Sigma-Aldrich; product name: Carbon nano tube; single-walled; ≥ 98%; carbon base), and a spherical carbon material precursor (Sigma-Aldrich; product name: Carbon (glassy, spherical powder, 2-12 μm)) having an average particle size of 2 μm, in weight ratios of 95 and 5, was introduced into a reactor containing 100 mL of acetone, and stirred. Thereafter, 100 g of cyanoacrylate adhesive (Loctite; product name: Loctite401) was introduced into the reactor to initiate a reaction. After the reaction was finished, the reaction product was dried in a vacuum oven at 80° C. for 3 hours and then pulverized. 2 g of the pulverized material was left at 120° C. for 10 minutes in an N₂ and H₂ atmosphere, and left at 400° C. for 1 hour, and heat treatment was performed with respect to the result through CVD, thereby obtaining carbon structure powders including a linear carbon material.

### Experimental Example 1

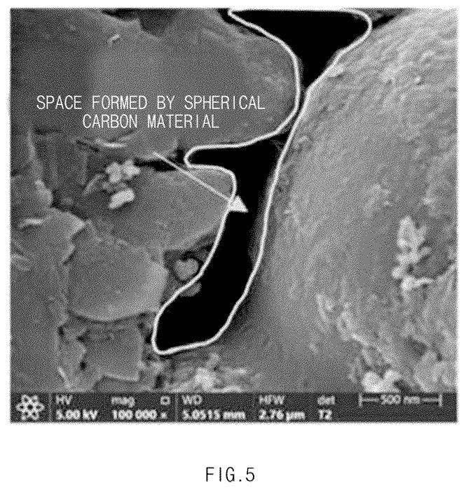

A slurry was prepared by dispersing the carbon structure powders prepared in Embodiment 1, Super P, and PVDF, in weight ratios of 90:5:5, respectively, in NMP. The prepared slurry was cast on an anode current collector having a thickness of 10 μm and including nickel foil and dried, to manufacture electrodes (an anode current collector having an intermediate layer). The loading amount of the prepared electrode was in the range from 0.9 mg/cm² to 1.3 mg/cm², and the thickness of the intermediate layer was 10 μm. FIG. 5 illustrates an SEM image of the carbon structure contained in the manufactured electrode. The SEM image was captured through a scanning electron microscope (Thermofisher; Apreo 2S).

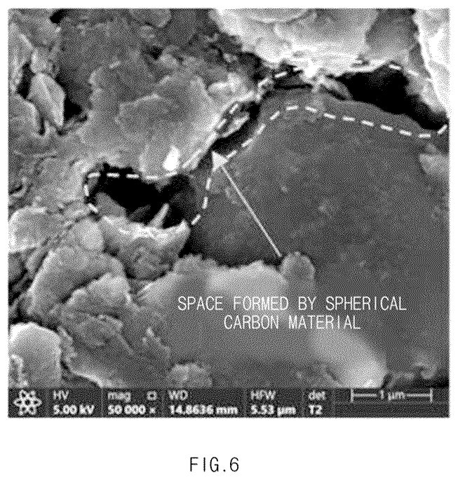

Thereafter, the electrode manufactured above was pressed under pressure (100 MPa). An SEM image of the carbon structure contained in the pressed electrode is illustrated in FIG. 6. The SEM image was captured through a scanning electron microscope (Thermofisher; Apreo 2S, Thermofisher).

Referring to FIG. 5, it can be seen that an empty space was formed between the spherical carbon material and the layered carbon material included in the carbon structure. Referring to FIG. 6, it can be seen that the empty space was maintained, even if the electrode is pressed.

### Experimental Example 2

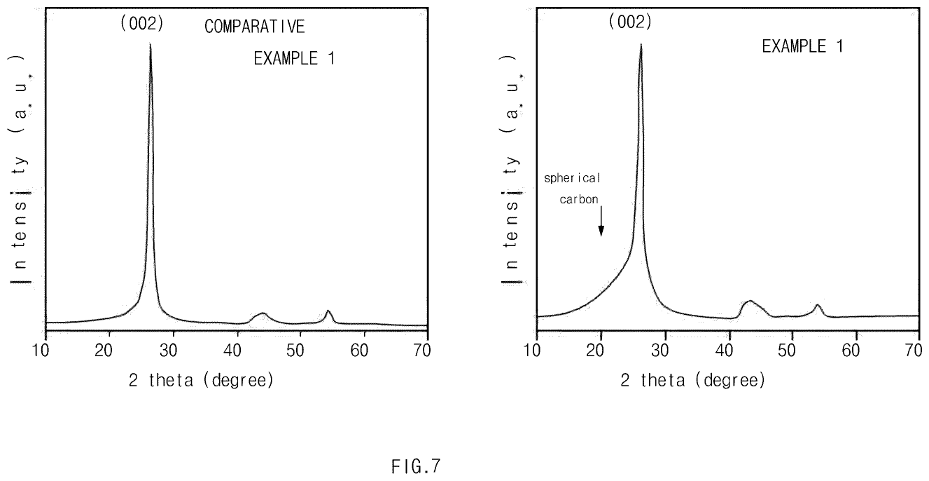

An XRD spectrum was obtained with respect to the carbon structure powders prepared in each of Embodiment 1 and Comparative example 1 through the measurement of an X-ray spectrometer (manufactured by Rigaku; product name: Miniplex) under the conditions of a voltage of 40 kV, a current of 15 mA, Cukα, 2θ (brag angle)=10° to 70°, and a scan speed=2°/60 sec, and is illustrated in FIG. 7.

Referring to FIG. 7, it can be seen that the FWHM of a (002) peak, which was observed around an angle ranging from 10° to 40°, was measured using the measured XRD spectrum, was 3.12° in Embodiment 1, and 0.528° in Comparative example 1. In addition, for Embodiment 1, it can be seen that a shoulder peak of the (002) peak was observed in a region having an angle from 20° to 25°. This may imply that the material is more amorphous, when compared to Comparative example 1.

### Experimental Example 3

### <BJH Pore Distribution Data>

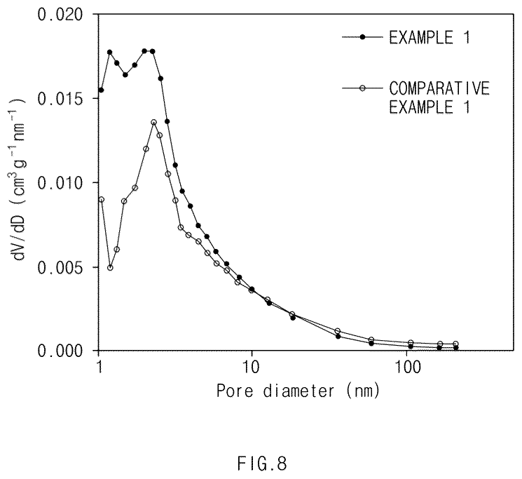

The pore size distribution of the carbon structure powders according to the embodiment and the comparative example was analyzed using a specific surface area analyzer (BEL Japan; BELORP-max). The assay was performed in compliance with the standard measurement manner of ASTM D4222. A Barrett-Joyner-Halenda (BJH) plot obtained through the analysis is illustrated in FIG. 8. In addition, a BJH average pore diameter was measured using the above plot. The BJH average pore diameter according to Embodiment 1 was measured to be 5.50 nm, and the BJH average pore diameter of Comparative Example 1 was measured to be 7.15 nm.

### <BET Specific Surface Area and Micropore Distribution Data Measurement>

3 g of carbon structure powders according to the Embodiment and the Comparative example was taken, and BET specific surface area and Micropore distribution data were measured with 3 g of carbon structure powders according to the Embodiment and the Comparative example, and based on amount of nitrogen gas adsorption using a Micromeritics TriStarr II under a nitrogen atmosphere. The BET specific surface area according to Embodiment 1 was measured to be 121 m²/g, and the BET specific surface area of Comparative example 1 was measured to be 80.1 m²/g.

Referring to FIG. 8, it can be seen that the carbon structure according to Embodiment 1 is larger than the carbon structure according to comparative example 1 in terms of the number of air pores distributed in the range from 1 nm to 8 nm, and is smaller than the carbon structure according to Comparative example 1 in an average air pore diameter.

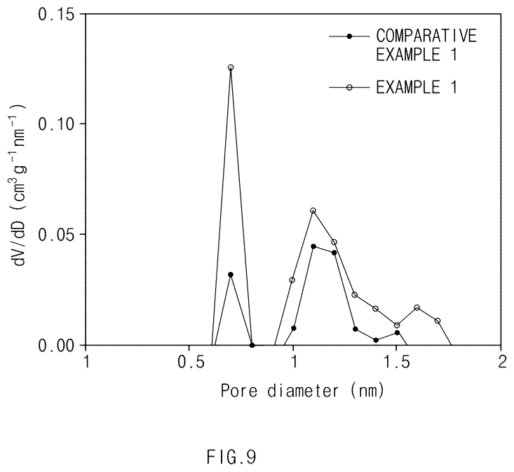

Referring to FIG. 9, it can be seen that the carbon structure according to Embodiment 1 is larger than the carbon structure according to Comparative example 1 in terms of the number of air pores having a maximum size of 2 nm. Referring to the BET specific surface area measured as described above, it may be recognized that the carbon structure according to Embodiment 1 is larger than the carbon structure according to Comparative example 1 in the BET specific surface area. Accordingly, it may be recognized that the carbon structure according to Embodiment 1 includes more spherical carbon materials as compared to the carbon structure according to Comparative example 1, thereby forming a new space structure.

### Experimental Example 4

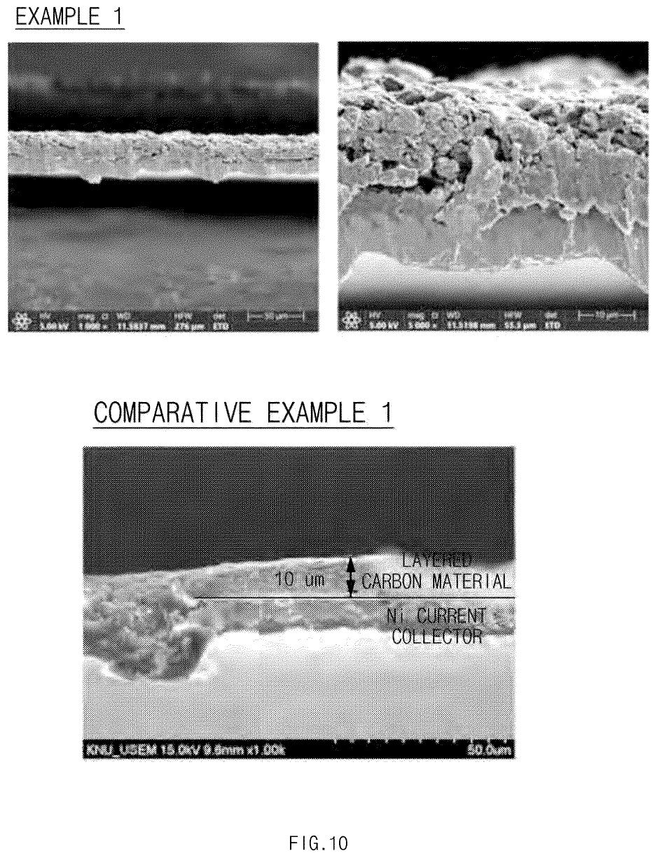

A slurry was prepared by dispersing the carbon structure powders prepared in Embodiment 1 and Comparative examples 1, Super P, and PVDF, in weight ratio of 90:5:5, respectively, in NMP. The prepared slurry was cast on an anode current collector having a thickness of 10 μm and including nickel foil and dried, thereby manufacturing electrodes (anode current collectors having an intermediate layer). The SEM image of the cross-section of each of electrodes according to Embodiment 1 and Comparative example 1 is illustrated in FIG. 10. The SEM image was captured through a scanning electron microscope (Thermofisher; Apreo 2S).

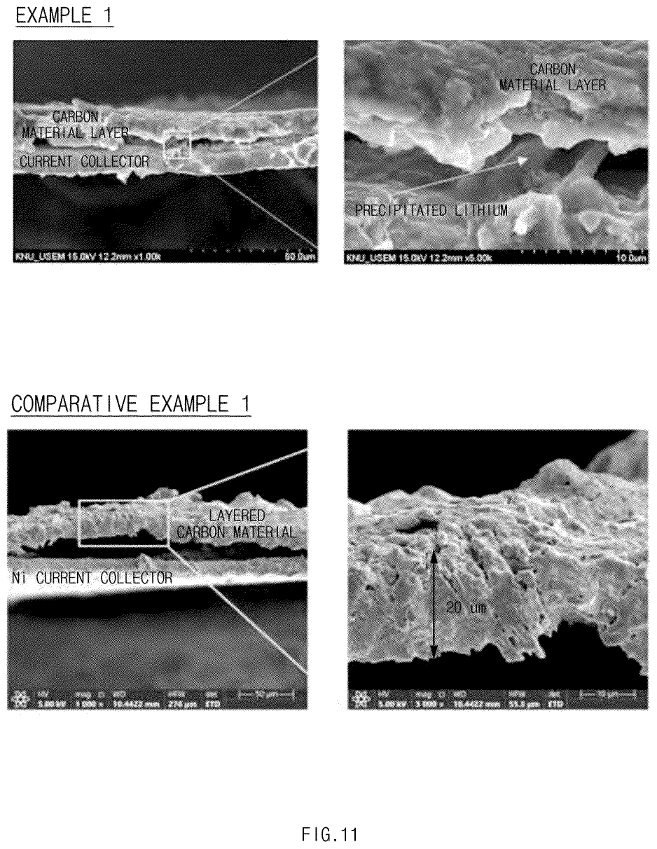

1.0 mAh/cm² of lithium was deposited on each electrode manufactured thereafter, and the SEM image of the cross-section of each electrode deposited with the lithium is illustrated in FIG. 11. The SEM image was captured through a scanning electron microscope (Thermofisher; Apreo 2S).

Referring to FIGS. 10 and 11, for the electrode including the carbon structure according to Embodiment 1, it can be seen that, after the lithium was deposited, the lithium was precipitated in a separation space between the spherical carbon material and the layered carbon material such that the empty space was disappeared, thereby making a dense form without changing the thickness of the intermediate layer, and with lithium precipitated under the intermediate layer. For the electrode including the carbon structure according to Comparative example 1, it can be seen that the lithium was precipitated inside the intermediate layer, such that the thickness of the intermediate layer was expanded to a value in a range from 10 μm to 20 μm. In addition, additional lithium was not precipitated under the intermediate layer. Accordingly, it may be that a mechanism by which lithium is deposited on the carbon structure according to Embodiment 1 is different from the mechanism that lithium is deposited on the carbon structure according to Comparative example 1,

### Experimental Example 5

Slurry was prepared by dispersing the carbon structure powders prepared in Embodiment 1, Comparative examples 1, and Comparative example 2, Super P, and PVDF, in weight ratio of 90:5:5, respectively, in NMP. The prepared slurry was cast on an anode current collector having a thickness of 10 μm and including nickel foil and dried, thereby manufacturing electrodes (anode current collectors having an intermediate layer). Thereafter, 90 mg of the solid electrolyte Li₆PS₅Cl_{0.5}Br_{0.5} powders was added to each electrode and compressed under the pressure of 200 MPa to form the solid electrolyte layer, and lithium foil was compressed the structure to manufacture a half-cell.

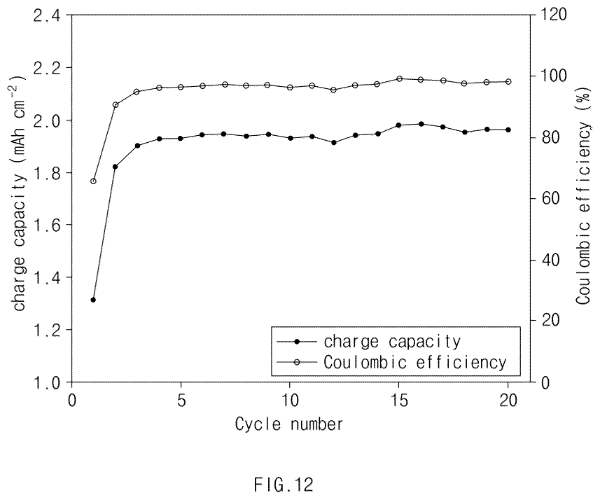

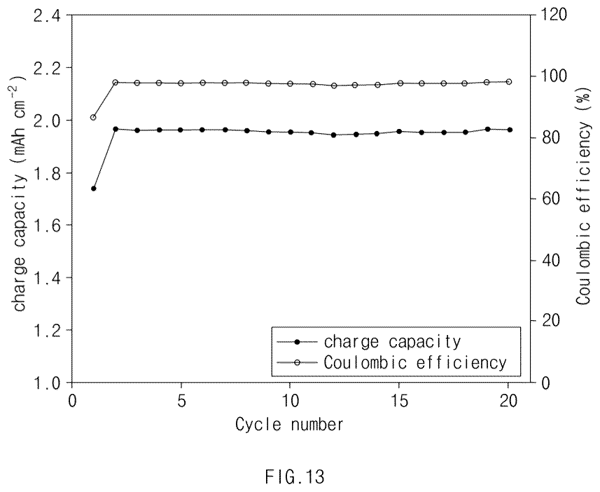

When a charging operation is performed until 4.2 V at the current density of 1.0 mA/cm² and a discharging operation is performed until 2.8 V at the current density of 1.0 mA/cm² at room temperature and a pressure of 15 MPa, in one cycle. The charging operation and the discharging operation were repeated to 20-th cycle under the above charging and discharging condition. A capacity retention rate and Coulombic efficiency were measured per cycle, and the measurement result is illustrated in the form of a graph of FIG. 12 (Comparative example 1) and FIG. 13 (Embodiment 1) for each of half-cells according to Embodiment 1 and Comparative example 1.

Referring to FIGS. 12 and 13, it can be seen that the half-cell including the carbon structure according to Embodiment 1 is improved relative to the half-cell including the carbon structure according to Comparative example 1, at least in initial efficiency and average efficiency. This result may arise from the lithium deposition mechanism recognized in Experimental example 4.

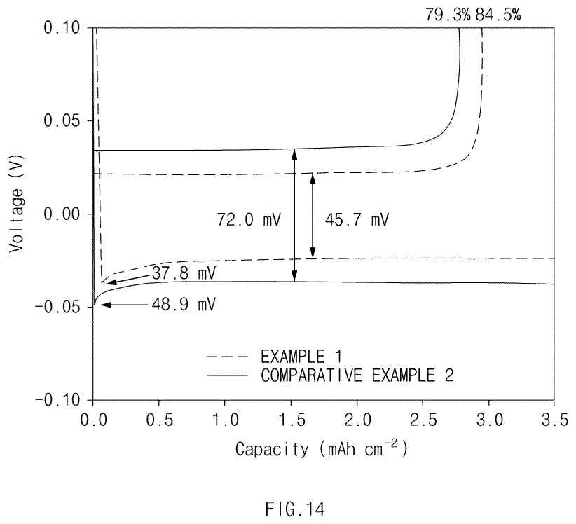

In addition, lithium having the capacity of 3.5 mAh/cm² was deposited at the current density of 1.167 mA/cm² under a pressure of 15 MPa and room temperature, with respect to each of half-cells according to Embodiment 1 and Comparative example 2. The initial driving characteristic of each of the half-cells is illustrated in the graph of FIG. 14. The nucleation overvoltage, the driving overvoltage, and the initial efficiency measured in each of Embodiment 1 and Comparative example 2 are shown in Table 1 based on the graph of FIG. 14.

TABLE 1

| | Nucleation | Driving | Initial |
|---|---|---|---|
| | overvoltage | overvoltage | efficiency |
| Embodiment 1 | 37.8 mV | 45.7 mV | 84.5% |
| Comparative example 2 | 48.9 mV | 72.0 mV | 79.3% |

Referring to FIG. 14 and Table 1, it can be seen that the nucleation overvoltage and driving overvoltage according to Embodiment 1 were lower than the nucleation overvoltage and the driving overvoltage according to Comparative example 2. Accordingly, it may be that lithium metal was deposited more densely (i.e., at many more positions/places) in the carbon structure powders according to Embodiment 1. In addition, it can be seen that the initial efficiency according to Embodiment 1 is higher than the initial efficiency according to Comparative example 2. Accordingly, it may be that the amount of lithium irreversibly reacted during the initial charging and discharging according to Embodiment 1 was smaller than the amount of lithium irreversibly reacted during the initial charging and discharging according to Comparative example 2.

As described above, according to an embodiment of the present disclosure, the anodeless all solid state battery may prevent the growth or formation of lithium dendrites.

According to an embodiment of the present disclosure, the anodeless all solid state battery includes the electrode for the all solid state battery and can prevent lithium from making direct contact with the solid electrolyte, thereby exhibiting an excellent lifespan characteristic and an excellent battery characteristic.

Although the present disclosure has been described with reference to various aspects, exemplary embodiments, and illustrative drawings, the present disclosure is not limited thereto, but may be variously modified and altered by those skilled in the art to which the present disclosure pertains without departing from the spirit and scope of the present disclosure claimed in the following claims.

What is claimed is:

1. An electrode for an all solid state battery, the electrode comprising:
a current collector; and
an intermediate layer comprising a carbon structure disposed on the current collector,
wherein the carbon structure comprises:
a spherical carbon material; and
a layered carbon material;
wherein the layered carbon material and the spherical carbon material are spaced in a configuration that forms a lithium deposition separation space.

2. The electrode of claim 1, characterized by a primary X-ray diffraction (XRD) peak for the carbon structure observable in a region having 2θ ranging from 10° to 40°, and
a shoulder peak on the primary peak that is observed in a region having 2θ ranging from 20° to 25°.

3. The electrode of claim 1, characterized by a primary XRD peak for the carbon structure having a full width at half maximum (FWHM; 2θ) ranging from 2° to 5°.

4. The electrode of claim 1, characterized by a Brunauer-Emmett-Teller (BET) surface area of the carbon structure ranging from 100 m²/g to 160 m²/g.

5. The electrode of claim 1, characterized by a Barrett-Joyner-Halenda (BJH) average pore diameter of the carbon structure ranging from 3.5 nm to 6.5 nm.

6. The electrode of claim 1, wherein the layered carbon material includes at least one of graphene platelet, stratified carbon, or a combination of the graphene platelet and the stratified carbon.

7. The electrode of claim 1, wherein the layered carbon material has a surface area ranging from 1,000 m²/g to 2,600 m²/g.

8. The electrode of claim 1, wherein the spherical carbon material includes at least one of glassy carbon, hard carbon, soft carbon, or a combination of any two or more of glassy carbon, hard carbon, and soft carbon.

9. The electrode of claim 1, wherein the spherical carbon material has an average particle diameter ranging from 0.2 μm to 20 μm.

10. An anodeless all solid state battery comprising:
an anode current collector;
an intermediate layer comprising a carbon structure disposed on the anode current collector;
a solid electrolyte layer disposed on the intermediate layer;
a cathode active material layer disposed on the solid electrolyte layer and including a cathode active material; and
a cathode current collector disposed on the cathode active material layer,
wherein the carbon structure comprises:
a spherical carbon material and a layered carbon material wherein the spherical and layered carbon materials are spaced in a configuration that forms a lithium deposition separation space.

11. The anodeless all solid state battery of claim 10, wherein when in a charged state, the anodeless all solid state battery is configured to deposit a lithium ion in the lithium deposition separation space of the intermediate layer.

12. The anodeless all solid state battery of claim 11, wherein the intermediate layer comprise a structure that is adapted to deposit the lithium ion in the lithium deposition separation space of the intermediate layer through a Coble creep mechanism.

13. The anodeless all solid state battery of claim 11, wherein when in a fully charged state, the anodeless all solid state battery is configured to comprise a lithium deposition body interposed in a separation space of the intermediate layer, and
further comprises a lithium deposition layer interposed between the intermediate layer and the anode current collector.

14. The anodeless all solid state battery of claim 10, wherein the solid electrolyte layer comprises a sulfide-based solid electrolyte.

15. The electrode of claim 1, wherein the carbon structure comprises a weight ratio of spherical carbon material to layered carbon material of 1:1 to 1:19.

16. The electrode of claim 1, wherein the layered carbon material comprises an average diameter, D₅₀, ranging from 10 μm to 20 μm.

17. The electrode of claim 1, wherein the layered carbon material comprises thickness ranging from 10 nm to 100 nm.

18. The electrode of claim 1, wherein the spherical carbon material comprises an average diameter D₅₀ ranging from 0.4 μm to 18 μm.

19. The electrode of claim 1, wherein the spherical carbon material comprises an average diameter D₅₀ ranging from 1 μm to 4 μm.

20. A method of preparing the carbon structure of claim 1 comprising
mixing an amount of the spherical carbon material, or a precursor thereof, and an amount of the layered carbon material, or a precursor thereof, in a weight ratio of 1:1 to 1:19, respectively;
heat treating the mixture under conditions sufficient to generate a carbon structure comprising a configuration that forms deposition spaces that are sized to accept deposited lithium; and
pulverizing the carbon structure to form a powder.
